(19) United States
(12) Patent Application Publication
(10) Pub. No.: US 2025/0390522 A1
(43) Pub. Date: Dec. 25, 2025

(54) DEVICE AND METHOD FOR GENERATING RESPONSE FROM QUERY USING GENERATIVE MODEL

(71) Applicant: Samsung Electronics Co., Ltd., Suwon-si (KR)

(72) Inventors: Hoseon SHIN, Suwon-si (KR); Minju KIM, Suwon-si (KR); Hyeongseok KIM, Suwon-si (KR); Jaehyun PARK, Suwon-si (KR); Gajin SONG, Suwon-si (KR); Hyeoncheon JO, Suwon-si (KR)

(21) Appl. No.: 19/175,742

(22) Filed: Apr. 10, 2025

Related U.S. Application Data
(63) Continuation of application No. PCT/KR2025/099840, filed on Mar. 19, 2025.

(30) Foreign Application Priority Data
Jun. 21, 2024 (KR) 10-2024-0081047
Jul. 16, 2024 (KR) 10-2024-0093573

(51) Int. Cl. G06F 16/3329; G06F 16/334

(52) U.S. Cl. CPC G06F 16/33295; G06F 16/334

(57) ABSTRACT

An electronic device includes: a display; at least one processor, comprising processing circuitry; and a memory storing instructions, wherein at least one processor, individually and/or collectively, is configured to execute the instructions and to cause the electronic device to: based on obtaining a query for source data, extract a plurality of pieces of candidate data related to the query from the source data; select, from the extracted plurality of pieces of candidate data, input data based on contents of the plurality of pieces of candidate data; generate a response to the query by applying the query and the selected input data to a generative model; determine a partial response of the response derived from the selected input data of the response; and display, via the display, a visual representation indicating information regarding the selected input data in an area corresponding to the determined partial response.

### CROSS-REFERENCE TO RELATED APPLICATIONS

This application is a continuation of International Application No. PCT/2025/099840 designating the United States, filed on Mar. 19, 2025, in the Korean Intellectual Property Receiving Office and claiming priority to Korean Patent Application Nos. 10-2024-0081047 filed on Jun. 21, 2024, and 10-2024-0093573 filed on Jul. 16, 2024, in the Korean Intellectual Property Office, the disclosures of each of which are incorporated by reference herein in their entireties.

### BACKGROUND

### Field

The disclosure relates to a technology for generating a response from a query using a generative model.

### Description of Related Art

There have been great advancements in technology for generating responses to queries using generative models. However, the generative models do not necessarily generate reliable responses, and the responses generated by the models may have errors, which may lead to hallucinations.

The foregoing information may be provided as background art (or related art) for the purpose of enhancing the understanding of this disclosure. No determination or assertion is made as to whether the foregoing may be claimed as related art (or prior art) with respect to the disclosure or used to determine prior art.

### SUMMARY

An electronic device may include: a display; at least one processor, comprising processing circuitry; and a memory configured to store instructions, wherein at least one processor, individually and/or collectively, is configured to execute the instructions and to control the electronic device to: based on obtaining a query for source data, extract a plurality of pieces of candidate data related to the query from the source data; select, from the extracted plurality of pieces of candidate data, input data based on contents of the plurality of pieces of candidate data; generate a response to the query by applying the query and the selected input data to a generative model; determine a partial response of the response derived from the selected input data; and display, via the display, a visual representation indicating information regarding the selected input data, in an area corresponding to the determined partial response.

A method performed by an electronic device may include: extracting, based on obtaining a query for source data, a plurality of pieces of candidate data related to the query from the source data; selecting, from the extracted plurality of pieces of candidate data, input data based on contents of the plurality of pieces of candidate data; generating a response to the query by applying the query and the selected input data to a generative model; determining a partial response of the response derived from the selected input data; and displaying, via a display, a visual representation indicating information regarding the selected input data, in an area corresponding to the determined partial response.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an electronic device in a network environment, according to various embodiments.

FIG. 2 is a diagram illustrating an example artificial intelligence (AI) system, according to various embodiments.

FIG. 3 is a flowchart illustrating an example method by which an electronic device generates a response from a query, according to various embodiments.

FIG. 4 is a diagram illustrating an example interface with which an electronic device obtains a query and outputs a response, according to various embodiments.

FIG. 5 is a diagram illustrating an example operation in which an electronic device selects input data from a plurality of candidate data having the same content, according to various embodiments.

FIG. 6 is a diagram illustrating an example operation in which an electronic device selects input data from a plurality of candidate data having different contents, according to various embodiments.

FIG. 7A is a diagram illustrating an example response to a query generated by an electronic device using specified source data, according to various embodiments.

FIG. 7B is a diagram illustrating an example response to a query generated by an electronic device when no source data is specified, according to various embodiments.

FIG. 8 is a diagram illustrating an example operation in which an electronic device displays a visual representation indicating information about a generative model used to generate a response, according to various embodiments.

FIG. 9 is a diagram illustrating an example interface with which an electronic device obtains a query and outputs a response when user-provided data and search data are specified as source data, according to various embodiments.

FIG. 10 is a diagram illustrating an example interface with which an electronic device obtains a query and outputs a response when user-provided data is not specified as source data but search data is specified as the source data, according to various embodiments.

FIG. 11 is a diagram illustrating an example screen for specifying data related to a particular application as source data, according to various embodiments.

FIG. 12 is a diagram illustrating an example screen where an electronic device specifies source data based on a directory, according to various embodiments.

FIG. 13 is a diagram illustrating example screens where an electronic device includes a response, according to various embodiments.

FIG. 14 is a diagram illustrating an example configuration for performing operations of an electronic device, according to various embodiments.

### DETAILED DESCRIPTION

Hereinafter, various example embodiments will be described in greater detail with reference to the accompanying drawings. When describing the various embodiments with reference to the accompanying drawings, like reference numerals refer to like elements, and descriptions thereof are not repeated.

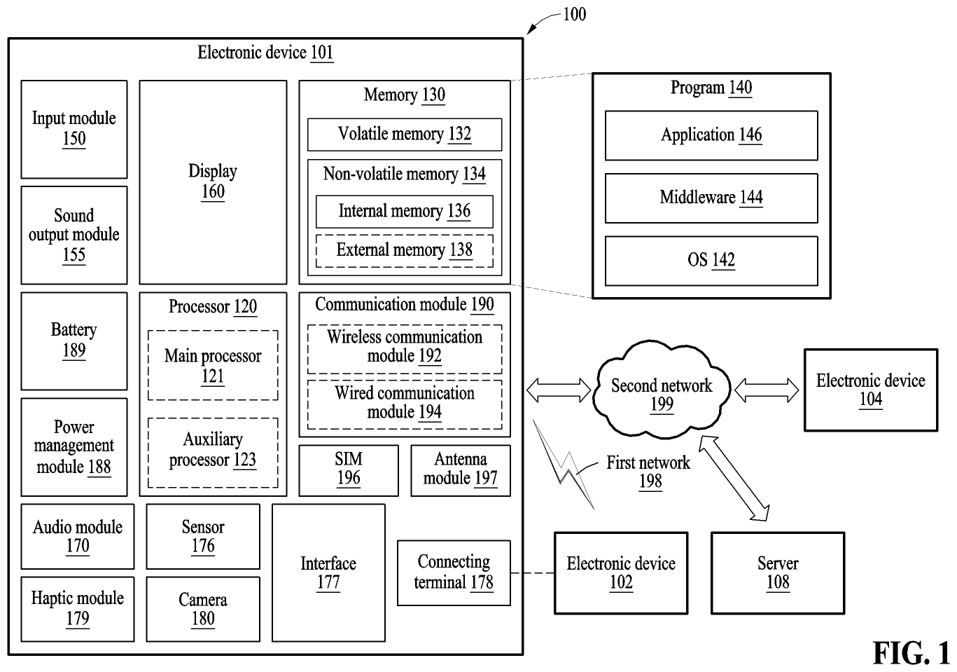

FIG. 1 is a block diagram illustrating an example configuration of an electronic device in a network environment, according to various embodiments.

FIG. 1 is a block diagram of an electronic device 101 in a network environment 100, according to various embodiments. Referring to FIG. 1, the electronic device 101 in the network environment 100 may communicate with an electronic device 102 via a first network 198 (e.g., a short-range wireless communication network), or communicate with at least one of an electronic device 104 and a server 108 via a second network 199 (e.g., a long-range wireless communication network). According to an embodiment, the electronic device 101 may communicate with the electronic device 104 via the server 108.

According to an embodiment, the electronic device 101 may include a processor 120, a memory 130, an input module 150, a sound output module 155, a display 160, an audio module 170, a sensor 176, an interface 177, a connecting terminal 178, a haptic module 179, a camera 180, a power management module 188, a battery 189, a communication module 190, a subscriber identification module (SIM) 196, or an antenna module 197. In various embodiments, at least one (e.g., the connecting terminal 178) of the above components may be omitted from the electronic device 101, or one or more other components may be added to the electronic device 101. In various embodiments, some (e.g., the sensor 176, the camera 180, or the antenna module 197) of the components may be integrated as a single component (e.g., the display 160).

The processor 120 may be implemented as one or more integrated circuits and/or circuitry and may execute various data processing. The processor 120 may include at least one electrical circuit and may perform distributed processing on instructions (or a program 140, data, etc.) stored in the memory 130, individually or collectively. The processor 120 may include a processor set including one or more processing circuits. The processor 120 may include any processing circuitry that is operative to control the performance and operations of one or more components (e.g., the memory 130, the display 160, the camera 180, the communication module 190, and/or the sensor 176) of the electronic device 100. The processor 120 may execute various instructions to provide a model, e.g., an artificial intelligence (AI) model, and/or an AI framework according to various embodiments.

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute various instructions to invoke a model, e.g., an artificial intelligence model, and/or to provide machine training and/or learning and/or an AI framework according to various embodiments. Any model (e.g., AI model) herein may include a processor including processing circuitry. The processor 120 may execute, for example, software (e.g., the program 140) to control at least one other component (e.g., a hardware or software component) of the electronic device 101 connected to the processor 120, and may perform various data processing or computation. According to an embodiment, as at least a part of data processing or computation, the processor 120 may store a command or data received from another component (e.g., the sensor 176 or the communication module 190) in a volatile memory 132, process the command or data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display 160, the sensor 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera 180 or the communication module 190) that is functionally related to the auxiliary processor 123. According to an embodiment, the auxiliary processor 123 (e.g., an NPU) may include a hardware structure specifically for artificial intelligence (AI) model processing. An AI model may be generated by machine learning. The learning may be performed by, for example, the electronic device 101, in which the AI model is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may alternatively or additionally include a software structure other than the hardware structure.

The memory 130 may store various pieces of data used by at least one component (e.g., the processor 120 or the sensor 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. The receiver may be implemented separately from the speaker or as a part of the speaker.

The display 160 may visually provide information to the outside (e.g., a user) of the electronic device 101. The display 160 may include, for example, a display, a hologram device, or a projector, and control circuitry to control its corresponding one of the display, the hologram device, and the projector. According to an embodiment, the display 160 may include a touch sensor adapted to sense a touch, or a pressure sensor adapted to measure an intensity of a force of the touch.

The audio module 170 may convert sound into an electric signal or vice versa. According to an embodiment, the audio module 170 may obtain the sound via the input module 150 or output the sound via the sound output module 155 or an external electronic device (e.g., the electronic device 102, such as a speaker or headphones) directly or wirelessly connected to the electronic device 101.

The sensor 176 may sense an operational state (e.g., power or temperature) of the electronic device 101 or an environmental state (e.g., a state of a user) external to the electronic device 101 and generate an electric signal or data value corresponding to the sensed state. According to an embodiment, the sensor 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. The sensor 176 may also include, for example, an inertial measurement unit (IMU).

The interface 177 may support one or more specified protocols to be used by the electronic device 101 to couple with an external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102).

According to an embodiment, the connecting terminal 178 may include, for example, an HDMI connector, a USB connector, an SD card connector, or an audio connector (e.g., a headphones connector).

The haptic module 179 may convert an electric signal into a mechanical stimulus (e.g., a vibration or a movement) or an electrical stimulus, which may be recognized by a user via their tactile sensation or kinesthetic sensation. The haptic module 179 may include, for example, a motor, a piezoelectric element, or an electric stimulator.

The camera 180 may capture still images and moving images. According to an embodiment, the camera 180 may include one or more lenses, one or more image sensors, one or more ISPs, and one or more flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell, which is not rechargeable, a secondary cell, which is rechargeable, or a fuel cell.

The communication module 190 may support establishing a direct (e.g., wired) communication channel or a wireless communication channel between the electronic device 101 and an external electronic device (e.g., the electronic device 102, the electronic device 104, or the server 108) and performing communication via the established communication channel. The communication module 190 may include one or more communication circuits. The communication module 190 may include one or more CPs that are operable independently from the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device, for example, the electronic device 104, via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., an LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4th generation (4G) network, and a next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., an mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., an antenna array). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to various embodiments, another component (e.g., a radio frequency integrated circuit (RFIC)) other than the radiating element may be additionally formed as a part of the antenna module 197.

According to various embodiments, the antenna module 197 may form an mmWave antenna module. According to an embodiment, the mmWave antenna module may include a PCB, an RFIC on a first surface (e.g., a bottom surface) of the PCB or adjacent to the first surface of the PCB and capable of supporting a designated high-frequency band (e.g., a mmWave band), and a plurality of antennas (e.g., an antenna array) disposed on a second surface (e.g., a top or a side surface) of the PCB, or adjacent to the second surface of the PCB and capable of transmitting or receiving signals in the designated high-frequency band.

At least some of the components described above may be coupled mutually and exchange signals (e.g., commands or data) therebetween via an inter-peripheral communication scheme (e.g., a bus, general-purpose input and output (GPIO), serial peripheral interface (SPI), or mobile industry processor interface (MIPI)).

According to an embodiment, commands or data may be transmitted or received between the electronic device 101 and the external electronic device (e.g., the electronic device 104) via the server 108 coupled with the second network 199.

Each of the external electronic devices (e.g., 102 and 104) and the server 108 may be a device of the same type as or a different type from the electronic device 101. According to an embodiment, all or some of operations to be executed by the electronic device 101 may be executed by one or more of the external electronic devices (e.g., 102 and 104) or the server 108. For example, if the electronic device 101 needs to perform a function or a service automatically, or in response to a request from a user or another device, the electronic device 101, instead of, or in addition to, executing the function or service, may request one or more external electronic devices to perform at least a part of the function or service. The one or more external electronic devices receiving the request may perform the at least part of the function or the service requested, or an additional function or an additional service related to the request and may transfer a result of the performance to the electronic device 101. The electronic device 101 may provide the result, with or without further processing of the result, as at least part of a response to the request.

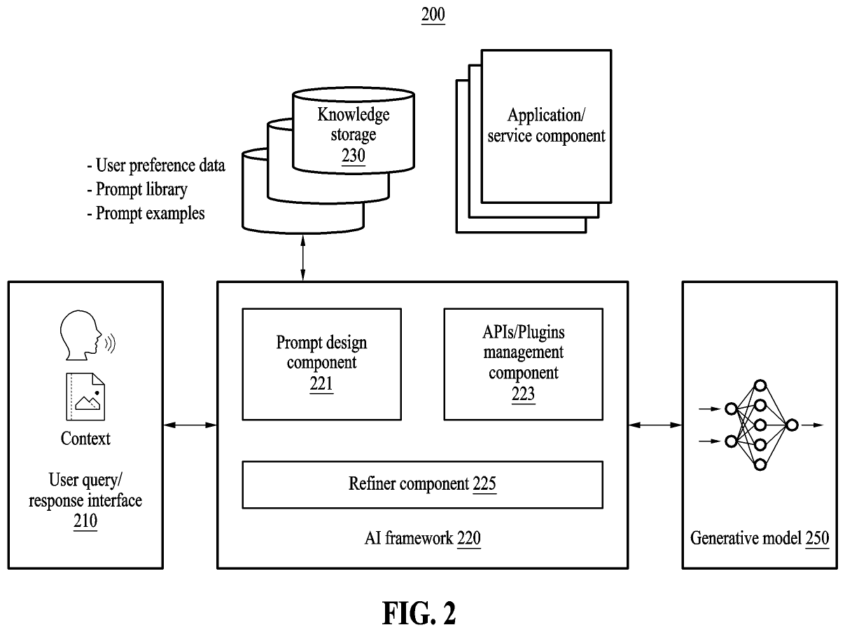

FIG. 2 is a diagram illustrating an example artificial intelligence (AI) system, according to various embodiments.

In an AI system (hereinafter, “system”) 200, a user query/response interface 210 may receive a user input. The user input may be an input of a type of natural language, image, audio, and/or video. The user input may be transmitted along with context information. The context information may include various side information related to a time point at which the user input is input to the system 200. The context information may include, for example, application information about an application currently used by a user or location information about a location of the user. The user input may also be an input of a mixed type of two or more of natural language, image, audio, video, and/or context information described above. The user input may also include a non-natural language input, such as, one selecting from a menu.

The user query/response interface 210 may provide the user with an output from a generative AI system. The output may include a natural language-based response and/or specific content. The output may also include an action requested by the user.

An AI framework 220 may receive a user input. Based on the user input (e.g., a query from the user), the AI framework 220 may coordinate and control one or more components required to perform an action corresponding to the intent of the user.

The user input received from the user query/response interface 210 may be transmitted to a prompt design component 221. The prompt design component 221 may be used to generate a prompt suitable as an input to a generative model 250 (e.g., a large language model (LLM) and/or a large multimodal model (LMM)) based on the user input.

The prompt design component 221 may include various circuitry and/or executable program instructions and be an AI component that uses machine learning algorithms or neural networks. The prompt design component 221 may learn over time to generate an improved prompt. To generate the prompt based on the user input, the prompt design component 221 may access a knowledge storage 230. The knowledge storage 230 may store user preference data, a prompt library, and/or prompt examples. The prompt design component 223 may provide the generated prompt to the generative model (e.g., LLM and/or LMM).

An APIs/Plugins management component 223 may include various circuitry and/or executable program instructions and communicate with an external information source based on a request for additional information when the user input is transmitted to the generative model 250.

The APIs/Plugins management component 223 may include various circuitry and/or executable program instructions and establish a communication channel for communication with an external entity of the system 200, via an application programming interface (API). Through the communication channel, the APIs/Plugins management component 223 may enable the AI framework 220 to access various data sources. In this case, information obtained from a data source may be used along with the user input by the prompt design component 221 to generate a prompt or may be used as an input to the generative model 250.

In a case where a final action corresponding to the user input, rather than an intermediate action, needs to be performed by an application or service, the APIs/Plugins management component 223 may request the final action via the API.

A refiner component 225 may include various circuitry and/or executable program instructions and fine-tune the output from the generative model 250. For example, the refiner component 225 may determine a relevance level (e.g., score) between the output (e.g., content) of the generative model 250 and the user input. For example, the refiner component 225 may determine whether the output includes biased information (e.g., selective information). For example, the refiner component 225 may determine whether the output includes harmful information (e.g., violent content and/or profanity).

The refiner component 225 may determine a matching level (e.g., score) between the output of the generative model 250 and the user input (e.g., the intent of the user input). In response to a determination that the output of the generative model 250 does not match the user input, the refiner component 225 may modify the output such that it matches the user input.

The refiner component 225 may provide hints (e.g., hints for generating prompts) to the user such that the user obtains information matching the intent of the user from the generative model 250.

The generative model 250 may refer to a model including an AI neural network that generates new data (e.g., text, images, audio, and/or video) based on a user input (e.g., a user utterance). The generative model 250 may include an image generative model and/or a language generative model.

The image generative model may include a generative adversarial network (GAN) and/or a variational autoencoder (VAE). An example of the image generative model may be a diffusion-based generative model which has the structure of a VAE and a transformer.

The language generative model (e.g., ChatGPT) may be a model trained to generate a statistically most appropriate output based on an input. The language generative model may include an LLM. The LLM may identify different types of input, such as, text, image, audio (e.g., speech), and/or video, and generate new data corresponding to the input.

In various embodiments, an electronic device (e.g., the electronic device 101 of FIG. 1) may use the AI system 200 to obtain new data generated by the generative model 250. For example, the electronic device may include a portion or entirety of the AI system 200 and may use the AI system 200 to generate new data (e.g., on-device). The AI system 200 may be implemented as a device (e.g., the electronic devices 102 and 104, and the server 108 of FIG. 1) external to the electronic device, and the electronic device may receive new data generated using the AI system 200 outside the electronic device from the AI system 200 (e.g., on-cloud).

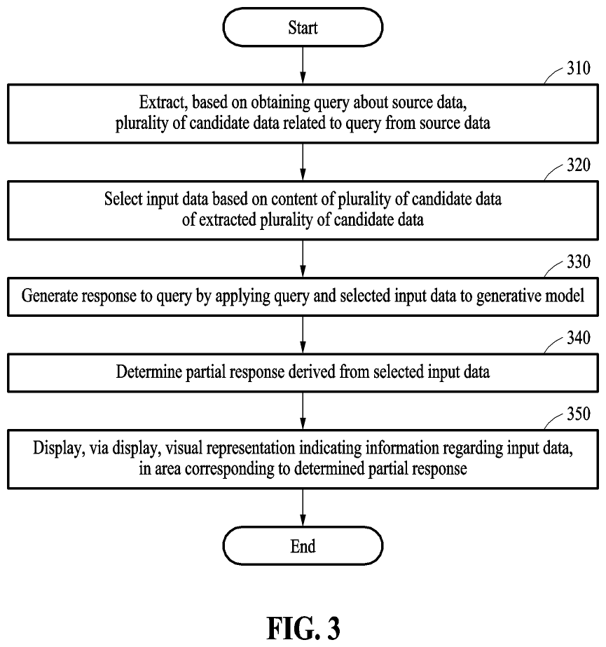

FIG. 3 is a flowchart illustrating an example method by which an electronic device generates a response from a query, according to various embodiments.

An electronic device (e.g., the electronic device 101 of FIG. 1), according to an embodiment, may obtain a query for source data. The query may also be referred to herein as a user query, which is a query generated based on a user input. The source data may refer to data available to the electronic device to generate a response to the query. The source data may include at least one of the followings: at least a portion of internal data stored in a memory (e.g., the memory 130 of FIG. 1) of the electronic device, at least a portion of external device data stored in another electronic device (e.g., the electronic device 102 of FIG. 1 and the electronic device 104 of FIG. 1) connected to the electronic device, and search data obtainable through a search server.

The other electronic device connected to the electronic device may include a device that has established direct communication with the electronic device and/or a device that has established direct communication with an intermediate device (e.g., a server) that has established direct communication with the electronic device. For example, in a case where the other electronic device uploads (e.g., backs up) data from the other electronic device to the intermediate device (e.g., the server), and the electronic device has access to data stored in the intermediate device (e.g., the server), the other electronic device may be determined to be connected to the electronic device via the intermediate device (e.g., the server).

In various embodiments, the internal data and the external device data may be collectively referred to as “user-provided data.”

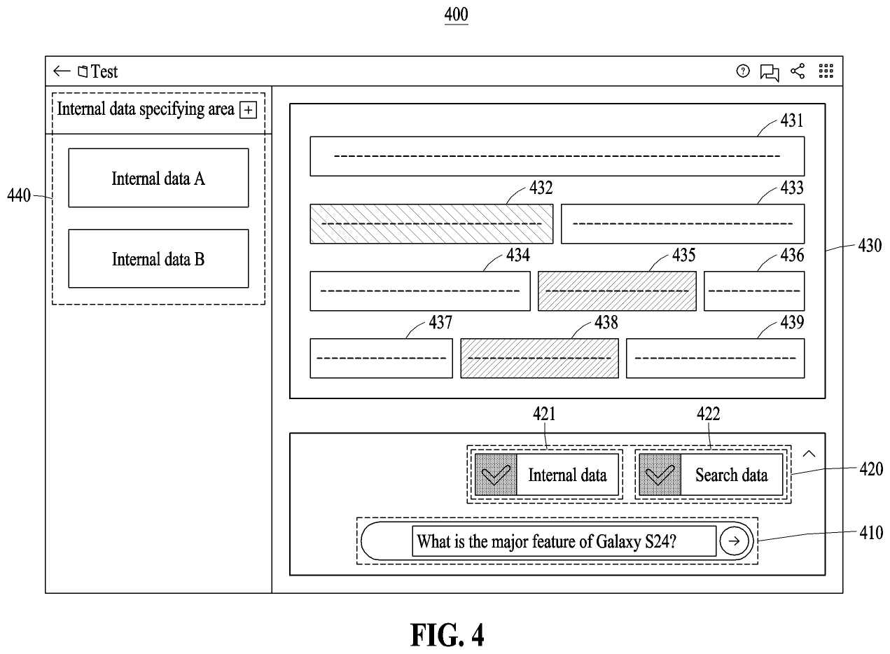

The electronic device may specify the source data based on the user input. For example, the source data may be specified by the user based on at least one of an application, a directory (e.g., a folder) in which the internal data is stored, or an external device that stores the external device data. In a case where the source data is specified through a specific application, data generated or processed (e.g., received from and/or transmitted to another electronic device) via the specific application may be specified as the source data. In a case where the source data is specified through a specific directory, the internal data stored in the specific directory may be specified as the source data. In a case where the source data is specified through a specific external device, data stored in and/or received from the specific external device may be specified as the source data. Examples of an operation to specify source data based on a user input and/or examples of an interface for specifying source data are described in greater detail below with reference to FIGS. 4, 9, 10, 11, and 12.

In various embodiments, the source data is not limited to being specified based on a user input, but the electronic device may also specify the source data based on a query.

In an embodiment, the electronic device may determine that the source data is the internal data stored in the memory of the electronic device based on the query being a query about private information of the user. When the electronic device determines that the user's intent determined by analyzing the query is to request a response based on the internal data, the electronic device may determine that the query is the query about the private information. For example, in a case where the electronic device obtains a query “Select a photo with a cat in it from among photos I took yesterday,” the electronic device may determine that the user is requesting a response that is based on the internal data, based on “among photos I took yesterday” in the query. For example, in a case where the electronic device obtains a query “Find me a trip photo my daughter sent me,” the electronic device may determine that the user is requesting a response that is based on the internal data, based on “my daughter sent me” in the query.

In an embodiment, the electronic device may specify the source data based on whether the query is answerable with the internal data. For example, the electronic device may obtain summary data of the internal data stored in the memory. The summary data, which is data summarizing the internal data, may include one or more topics extracted from the internal data. Based on obtaining the query, the electronic device may determine whether the query is answerable with the internal data, using the summary data and the query. Based on the query being answerable with the internal data, the electronic device may specify the source data including the internal data. Based on the query not being answerable with the internal data, the electronic device may specify the source data including at least one of the external device data or the search data. Based on the query not being answerable with the internal data, the electronic device may specify, as the source data, the internal data and the at least one of the external device data or the search data.

After specifying the source data, the electronic device may obtain (e.g., collect) at least a portion of the specified source data.

For example, in a case where the electronic device specifies the external device data as the source data, the electronic device may obtain (e.g., receive), as the source data, external device data mapped to a specified external device or to an external device specified by an intermediate device (e.g., a cloud device) connected to the specified external device.

For example, in a case where the electronic device specifies the search data as the source data, the electronic device may generate a search request (e.g., a search word or a search image) based on the query. The electronic device may transmit the generated search request to an external device (e.g., a search engine or a search server). The electronic device may obtain, from the external device, a search result corresponding to the search request and information about the search result (e.g., an access path to a web page including the search result). The electronic device may determine, as the search data, at least a portion of the search result.

At operation 310, the electronic device may, based on obtaining a query, extract a plurality of pieces of candidate data related to the query from source data. The candidate data may refer to at least a portion of the source data that is related to the query. As described below regarding operation 320, the plurality of pieces of candidate data may have, for example, the same or similar content.

At operation 320, the electronic device may select input data from the extracted plurality of pieces of candidate data based on contents of the plurality of candidate data. The input data may refer to data selected from the plurality of pieces of candidate data to be used to generate a response to the query. The electronic device may select the input data to be used to generate the response to the query based on a result of comparing the respective contents of the plurality of pieces of candidate data.

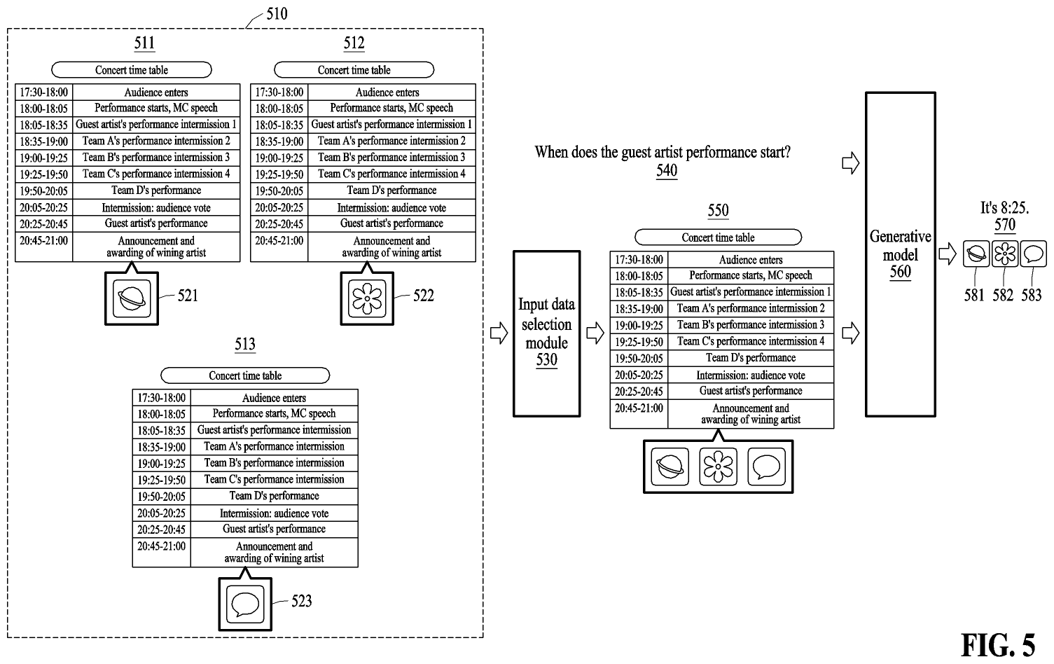

For example, in a case where content of first candidate data and content of second candidate data are the same, the electronic device may select, as the input data, one of the first candidate data and the second candidate data. Selecting the input data when the content of the first candidate data and the content of the second candidate data are the same is described in greater detail below with reference to FIG. 5.

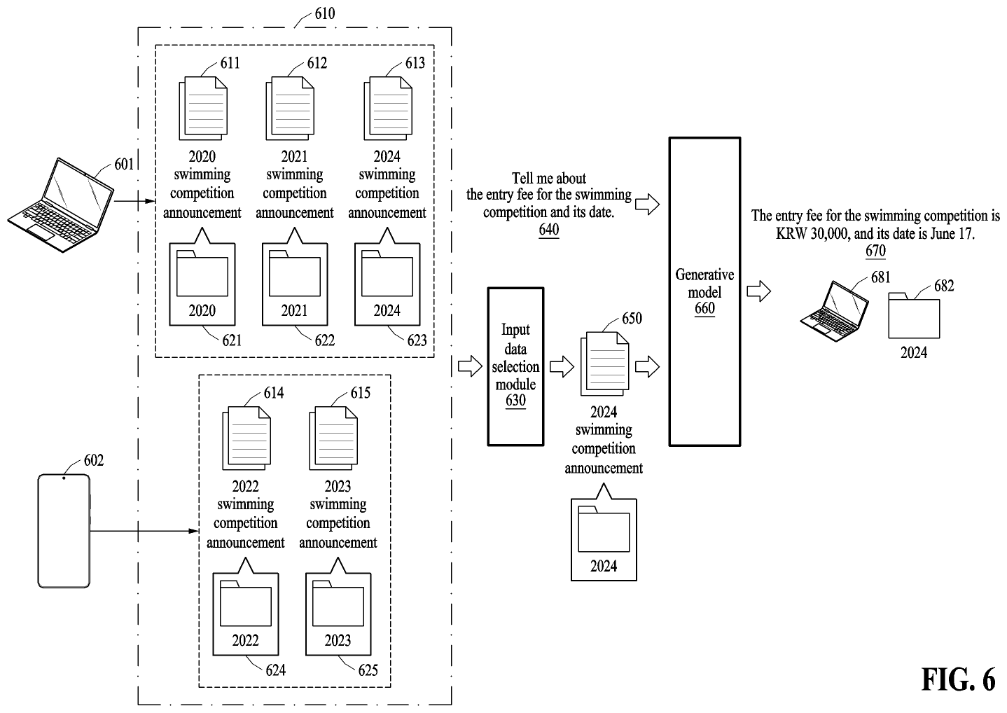

For example, in a case where the content of the first candidate data and the content of the second candidate data are different, the electronic device may select, as the input data, one of the first candidate data and the second candidate data or both the first candidate data and the second candidate data. Selecting the input data when the content of the first candidate data and the content of the second candidate data are different is described in greater detail below with reference to FIG. 6.

At operation 330, the electronic device may generate a response to the query by applying the query and the selected input data to a generative model (e.g., the generative model 250 of FIG. 2).

The electronic device may convert the query and the selected input data into an input format for the generative model. For example, the input data may include at least one of an image, a text, a video, or a document (e.g., Word, Slide show, or Spreadsheet). The electronic device may preprocess the input data that is to be input to the generative model by, for example, converting the input data into preprocessed input data of the input format for the generative model.

The response to the query may include an answer to a question asked in the query. For example, the response to the query may include a natural language-based text.

In an embodiment, the electronic device may select one generative model from among a plurality of candidate generative models based on at least one of the query, the source data, or the input data. The electronic device may generate the response by applying the query and the input data to the selected generative model.

For example, the plurality of candidate generative models may be selected based on a type of data included in the source data or the input data, such as, the internal data, the external device data, or the search data. The electronic device may select a first generative model based on the search data being included in the source data or the input data. The electronic device may select a second generative model based on the search data not being included in the source data or the input data (e.g., at least one of the internal data or the external device data being included in the source data or the input data).

For example, the plurality of candidate generative models may correspond to a plurality of operations, respectively. The plurality of operations may include at least one of a summary operation, an answer operation, a document generation operation, or a device control operation. For example, it may be selected based on an operation requested in the query. The electronic device may determine, from among the plurality of operations, the operation requested in the query and select a generative model corresponding to the operation requested in the query.

At operation 340, the electronic device may determine a partial response of the response that is derived from the selected input data.

The electronic device may obtain a plurality of candidate partial responses from the response. For example, the electronic device may classify components included in the response into the plurality of candidate partial responses based on grammatical and/or semantic criteria. For example, in a case where a text in the response includes a plurality of sentences, the electronic device may obtain each sentence as one candidate partial response. For example, in a case where the response includes images, the electronic device may obtain each image as one candidate partial response.

The electronic device may determine a similarity level between the plurality of candidate partial responses included in the response and the input data. For example, the electronic device may determine a similarity level between each candidate partial response and the input data. The electronic device may determine the similarity level between each candidate partial response and the input data, using a similarity calculation model. The similarity calculation model may refer to a model that is generated and/or trained to output, by being applied to an input including a candidate partial response and the input data, an output (e.g., a similarity score) indicating a matching and/or similarity level between the candidate partial response and the input data. The similarity calculation model may be built based on a machine learning model (e.g., a neural network or LLM).

The electronic device may determine at least one candidate response to be the partial response derived from the input data, based on the similarity level between each candidate partial response and the input data. For example, in response to the similarity level between a candidate partial response and the input data being greater than or equal to a threshold similarity level, the electronic device may determine that the candidate partial response is derived from the input data. In response to the similarity level between a candidate partial response and the input data being less than the threshold similarity level, the electronic device may determine that the candidate partial response is independent of the input data (e.g., that the candidate partial response is not derived from the input data). In response to the similarity level between the input data and all the candidate partial responses being less than the threshold similarity level, the electronic device may determine that no portion of the response is derived from the input data. In response to the similarity level between a particular candidate partial response and all the input data being less than the threshold similarity level, the electronic device may determine that the particular candidate partial response is not derived from the input data. When the particular candidate partial response is not derived from the input data, the electronic device may determine the particular candidate partial response as a partial response generated by the generative model, for example, a partial response derived from data learned by the generative model.

In an embodiment, the electronic device may determine, when applying a plurality of pieces of input data to the generative model, a partial response of the response that is derived from each input data. The electronic device may determine, from the plurality of candidate partial responses, one partial response or more than two partial response derived from each input data.

At operation 350, the electronic device may display, via a display, a visual representation indicating information regarding at least one candidate data of the plurality of pieces of candidate data in an area corresponding to the determined partial response.

In an embodiment, the electronic device may provide information regarding the input data, in the area corresponding to the partial response derived from the input data.

The visual representation may indicate information regarding the origin of the input data. The origin of the input data may include, for example, hardware (e.g., an external device) or software (e.g., an application) used to obtain or process the input data, and/or a location (e.g., a directory) where the obtained input data is stored.

The visual representation may indicate whether the input data is the internal data, the external device data, or the search data. For example, the visual representation may include a first visual representation (e.g., highlighted in blue) indicating that the input data is the internal data, a second visual representation (e.g., highlighted in yellow) indicating that the input data is the external device data, and a third visual representation (e.g., highlighted in red) indicating that the input data is the search data. An example where a visual representation indicates that input data is internal data or search data is described in greater detail below with reference to FIG. 4.

The visual representation may indicate at least one of an application used to obtain or process the input data, a directory (e.g., folder) in which the input data is stored, an access path (e.g., a uniform resource locator (URL)) for accessing a page including the input data, or an external device that has shared the input data with the electronic device.

For example, in a case where the input data is the internal data, the visual representation may include an icon of an application used to obtain (e.g., receive or generate) and/or process (e.g., share, transmit, convert, or modify) the input data. In a case where the input data is the search data, the visual representation may include an access path to a page (e.g., a web page) corresponding to the input data. In a case where the input data is the external device data, the visual representation may include a visual representation (e.g., an icon) indicating an external device that stores the input data and/or transmits the input data.

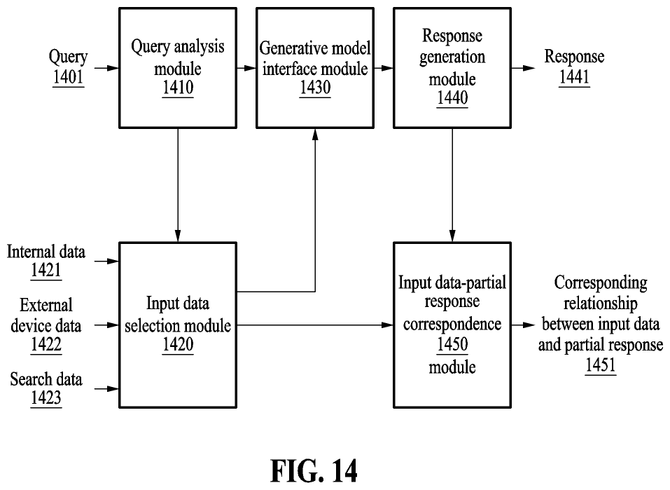

In various embodiments, the visual representation is not limited to indicating information regarding the origin of the input data. The visual representation may also include a visual representation based on at least a portion of the input data. For example, the visual representation may include a preview of at least a portion of the input data. Examples of the visual representation are described in greater detail below with reference to FIG. 14.

Although not explicitly shown in FIG. 3, the electronic device may further display, in addition to the visual representation indicating the information regarding the input data, a visual representation indicating information about candidate data that is not selected as the input data among the plurality of pieces of candidate data. For example, in a case where the electronic device generates a response by selecting first candidate data as the input data from between the first candidate data and second candidate data having the same content, the electronic device may display a second visual representation indicating information about the second candidate data, along with a first visual representation indicating information about the first candidate data. By displaying, in addition to the input data, information about candidate data having the same content as the input data, the electronic device may provide the user with both the information about the input data and the information about the candidate data having the same content as the input data.

Although not explicitly shown in FIG. 3, in a case where the electronic device determines that a portion (e.g., a partial response) of the response is not derived from the input data and/or is derived from data learned by the generative model, the electronic device may display a visual representation (e.g., an icon or highlight) indicating that the partial response is derived from the data learned by the generative model, in an area corresponding to the partial response. By displaying the partial response of the response generated by the generative model, the electronic device may inform the user of a risk of hallucination where the generative model has an error and guide the user to review the partial response.

FIG. 4 is a diagram illustrating an example interface with which an electronic device obtains a query and outputs a response, according to various embodiments.

An electronic device (e.g., the electronic device 101 of FIG. 1), according to an embodiment, may provide, via a display, an interface 400 for obtaining a query and outputting a response and/or information about the interface 400. For example, the interface 400 may include a query input area 410, a source data specifying area 420, a response output area 430, and/or an internal data specifying area 440.

The query input area 410 may include an area for receiving a user input to generate a query from a user.

The source data specifying area 420 may include a first button 421 for specifying at least a portion of internal data as source data, and a second button 422 for specifying search data as the source data.

The internal data specifying area 440 may refer to an area for specifying at least a portion of the internal data as the source data based on an application or a directory. By the internal data specifying area 440, the user may specify at least a portion of the internal data that is to be used to generate the response to the query.

The response output area 430 may include an area for outputting the response to the query. For example, as shown in FIG. 4, the response may include a first candidate partial response 431, a second candidate partial response 432, a third candidate partial response 433, a fourth candidate partial response 434, a fifth candidate partial response 435, a sixth candidate partial response 436, a seventh candidate partial response 437, an eighth candidate partial response 438, and/or a ninth candidate partial response 439.

The electronic device may determine a corresponding relationship between a plurality of candidate partial responses and input data. The corresponding relationship between the plurality of candidate partial responses and the input data may indicate that a particular candidate partial response is derived from at least a portion of the input data.

The electronic device may determine the second candidate partial response 432 as a partial response derived from the input data that is the internal data. For example, the electronic device may display a visual representation indicating that the input data is the internal data, in an area corresponding to the second candidate partial response 432.

The electronic device may determine the fifth candidate partial response 435 and the eighth candidate partial response 438 as a partial response derived from the input data that is the search data. For example, the electronic device may display a visual representation indicating that the input data is the search data, in areas corresponding to the fifth candidate partial response 435 and the eighth candidate partial response 438.

The electronic device may determine, as a partial response derived from training data of a generative model, the remaining candidate partial responses, such as, the first candidate partial response 431, the third candidate partial response 433, the fourth candidate partial response 434, the sixth candidate partial response 436, the seventh candidate partial response 437, and the ninth candidate partial response 439. As shown in FIG. 4, the electronic device may limit displaying visual representations in areas corresponding to the remaining candidate partial responses. However, examples are not limited thereto, and although not explicitly shown in FIG. 4, the electronic device may also display a visual representation indicating that the remaining candidate partial responses are derived from the training data of the generative model in the areas corresponding to the remaining candidate partial responses.

FIG. 5 is a diagram illustrating an example operation in which an electronic device selects input data from a plurality of candidate data having the same content, according to various embodiments.

According to an embodiment, the electronic device may store a plurality of pieces of data having the same content. For example, the electronic device may display a concert timetable image via an internet application 521. The electronic device may store first data 511 including the concert timetable image obtained via the internet application 521. The electronic device may, based on obtaining a user input (e.g., a screenshot input) requesting storage of the concert timetable image, store second data 512 including the concert timetable image via a photo application 522. The electronic device may transmit third data 513 including the concert timetable image to another electronic device via a messaging application 523. As a result, the plurality of pieces of data (e.g., the first data 511, the second data 512, and the third data 513) having the same content, e.g., the concert timetable image, may be stored.

The electronic device may obtain a query 540 (e.g., “When does the guest artist performance start?”). The electronic device may extract, from source data, the first data 511, the second data 512, and the third data 513 as a plurality of pieces of candidate data 510 related to the query 540. Each candidate data may be mapped to information about an application used to obtain or process corresponding candidate data. As shown in FIG. 5, the first data 511 may be mapped to information about the internet application 521, the second data 512 may be mapped to information about the photo application 522, and the third data 513 may be mapped to information about the messaging application 523.

In an embodiment, the electronic device may include an input data selection module 530 that selects input data 550 based on contents of the plurality of pieces of candidate data 510. The input data selection module 530 may select the input data 550 from the plurality of pieces of candidate data 510.

For example, based on content of first candidate data and content of second candidate data being the same, the input data selection module 530 may select one of the first candidate data and the second candidate data as the input data 550. The electronic device may select one of three or more pieces of candidate data as the input data 550, based on respective contents of the three or more pieces of candidate data being the same.

Whether the content of the first candidate data and the content of the second candidate data are the same may be determined based on content of the query 540. For example, the query 540 (e.g., “When does the guest artist performance start?”) may be a query about the start time of a guest artist performance. The first candidate data may include an image including content (e.g., “The guest artist performance starts at 8:25.”). The second candidate data may include a text including the content (e.g., “The guest artist performance starts at 8:25.”). Despite the difference in format between the first candidate data and the second candidate data, the electronic device may determine that the content queried in the query 540 included in the first candidate data and the content queried in the query 540 included in the second candidate data are the same. Even if, of the content included in the first candidate data, content different from the content queried in the query 540 is different from the content included in the second candidate data, the electronic device may determine that the first candidate data and the second candidate data have the same content for the query 540 when the content queried in the query 540 included in the first candidate data and the content queried in the query 540 included in the second candidate data are the same.

Referring to FIG. 5, in an embodiment, the input data selection module 530 may select, as the input data 550, the first data 511 that is first obtained and/or processed by the electronic device, based on the contents of the first data 511, the second data 512, and the third data 513 being the same.

In an embodiment, the input data selection module 530 may map all information (e.g., information about a particular application) mapped to each candidate data to the selected input data 550, based on the plurality of pieces of candidate data 510 having the same content. Referring to FIG. 5, the input data selection module 530 may map information about the internet application 521, information about the photo application 522, and information about the messaging application 523 to the first data 511 selected as the input data 550.

The electronic device may generate a response 570 by applying the query 540 and the input data 550 to a generative model 560. The electronic device may determine, from the response 570, a partial response derived from the input data 550. The electronic device may display, in an area corresponding to the partial response, a visual representation indicating information regarding the first candidate data and a visual representation indicating information regarding the second candidate data.

Referring to FIG. 5, the electronic device may determine that at least a portion of the response 570 is derived from the input data 550. The electronic device may display, in an area corresponding to the response 570, a visual representation indicating information regarding the input data 550. When the input data 550 is selected based on the plurality of pieces of candidate data 510 having the same content, the electronic device may display a visual representation indicating information regarding each candidate data, as the information regarding the input data 550.

Referring to FIG. 5, the electronic device may display, in the area corresponding to the response 570, a first visual representation 581 for the first data 511 (e.g., a visual representation indicating the internet application 521), a second visual representation 582 for the second data 512 (e.g., a visual representation indicating the photo application 522), and a third visual representation 583 for the third data 513 (e.g., a visual representation indicating the messaging application 523).

FIG. 6 is a diagram illustrating an example operation in which an electronic device selects input data from a plurality of candidate data having different contents, according to various embodiments.

According to an embodiment, the electronic device may store a plurality of pieces of data having different contents. For example, the electronic device may store announcements about annual swimming competitions.

The electronic device may obtain a query 640 (e.g., “Tell me about the entry fee for the swimming competition and its date”). For example, source data may include data stored in a first device 601 (e.g., external device data) and data stored in a second device 602 (e.g., internal data). For example, the first device 601 may be an external device of the electronic device, and the second device 602 may be the electronic device. The electronic device may extract, from the source data, first data 611, second data 612, and third data 613 of the data stored in the first device 601, and fourth data 614 and fifth data 615 of the data stored in the second device 602, as a plurality of pieces of candidate data 610 related to the query 640.

In FIG. 6, the first data 611 may be mapped to information about the first device 601 and/or a first directory 621 in which the first data 611 is stored, the second data 612 may be mapped to information about the first device 601 and/or a second directory 622 in which the second data 612 is stored, and the third data 613 may be mapped to information about the first device 601 and/or a third directory 623 in which the second data 612 is stored. The fourth data 614 may be mapped to information about the second device 602 and/or a fourth directory 624 in which the fourth data 614 is stored, and the fifth data 615 may be mapped to information about the second device 602 and/or a fifth directory 625 in which the fifth data 615 is stored.

In an embodiment, the electronic device may include an input data selection module 630 that selects input data 650 based on contents of the plurality of pieces of candidate data 610. The input data selection module 630 may select the input data 650 from the plurality of pieces of candidate data 610.

For example, based on content of first candidate data and content of second candidate data being different from each other, the input data selection module 630 may select, as the input data 650, candidate data that is obtained (e.g., generated, received, or stored) or processed (e.g., shared, transmitted, or modified) more recently than the other candidate data.

For example, as described above with reference to FIG. 5, whether the content of the first candidate data and the content of the second candidate data are the same or different may be determined based on content of the query 640. For example, the query 640 (e.g., “Tell me about the entry fee for the swimming competition and its date”) may be a query about the entry fee for a swimming competition and the date of the swimming competition. The first candidate data may have the content “The entry fee for the swimming competition is KRW 20,000 and the date of the swimming competition is June 29.” The second candidate data may have the content “The entry fee for the swimming competition is KRW 30,000 and the date of the swimming competition is June 17.” The electronic device may determine that the content queried in the query 640 included in the first candidate data is different from the content queried in the query 640 included in the second candidate data.

For example, the input data selection module 630 may include an obtainment timepoint and/or a processing timepoint for each candidate data. The obtainment timepoint for each candidate data may include a time at which corresponding candidate data is generated or a time at which the candidate data is stored in a device (e.g., the first device 601 or the second device 602). The processing timepoint for each candidate data may include a time at which corresponding candidate data is shared with or transmitted to another electronic device or a time at which the candidate data is modified. In a case where there is a plurality of processing timepoints for each candidate data based on a plurality of operations for each candidate data, the input data 650 may be selected based on a last one of the plurality of processing timepoints.

For example, based on respective contents of three or more pieces of candidate data being different from each other, the electronic device may select, as the input data 650, candidate data that is most recently generated or processed from among the three or more pieces of candidate data. Referring to FIG. 6, the input data selection module 630 may select, as the input data 650, the third data 613 that is most recently generated from among the first data 611, the second data 612, the third data 613, the fourth data 614, and the fifth data 615.

Although an example where the electronic device selects input data based on the obtainment timepoint and/or the processing timepoint from among a plurality of pieces of candidate data having different contents is primarily described with reference to FIG. 6, examples are not limited thereto. For example, the electronic device may select the input data based on the quality and/or confidence of the plurality of pieces of candidate data. In this example, when selecting the input data from a plurality of images, the electronic device may select the input data from the plurality of images based on at least one of resolution, blurring, and/or objects appearing in each image.

Based on the respective contents of the plurality of pieces of candidate data 610 being different from each other, the input data selection module 630 may map information about the selected input data 650 to the input data 650. Based on the respective contents of the plurality of pieces of candidate data 610 being different from each other, the input data selection module 630 may map the information only about the selected input data 650 to the input data 650, as opposed to mapping information about another candidate data together to the input data 650 based on the respective contents of the plurality of pieces of candidate data 610 being the same. Referring to FIG. 6, the input data selection module 630 may map information about the first device 601 and/or information about the third directory 623 to the third data 613 selected as the input data 650.

The electronic device may generate a response 670 by applying the query 640 and the input data 650 to a generative model 660. The electronic device may determine a partial response of the response 670 that is derived from the input data 650. The electronic device may display a visual representation indicating information regarding the input data 650 in an area corresponding to the partial response.

Referring to FIG. 6, the electronic device may determine that at least a portion of the generated response 670 is derived from the input data 650. The electronic device may display, in an area corresponding to the response 670, the visual representation indicating the information regarding the input data 650. Based on the information mapped to the input data 650 (e.g., the information about the first device 601 and/or the information about the third directory 623), the electronic device may display a visual representation 681 indicating the first device 601 and/or a visual representation 682 indicating the third directory 623.

Although an example where, when respective contents of a plurality of pieces of candidate data are different from each other, the electronic device selects, as input data, candidate data that is most recently generated or processed from among the plurality of pieces of candidate data is primarily described with reference to FIG. 6, examples are not limited thereto.

Although not explicitly shown in FIG. 6, when the contents of the plurality of pieces of candidate data are different, the electronic device may determine whether to select, as the input data, some of the plurality of pieces of candidate data or all of the plurality of pieces of candidate data, based on a category(s) of the contents of the plurality of pieces of candidate data.

In an embodiment, based on content of first candidate data and content of second candidate data being in the same category, the electronic device may select, as the input data, candidate data that is most recently generated or processed from between the first candidate data and the second candidate data, as described above.

In an embodiment, based on the content of the first candidate data and the content of the second candidate data being in different categories, the electronic device may select the first candidate data and the second candidate data as the input data.

In an embodiment, a category of content of candidate data may correspond to an item of a plurality of items queried in a query. For example, the plurality of items may be queried in the query. For example, a query (e.g., “Tell me about the entry fee for the swimming competition and its date”) may be a query about a first item (e.g., the entry fee for the swimming competition) and a second item (e.g., the date of the swimming competition). The electronic device may determine a category of content of each of the first candidate data and the second candidate data by one of the first item and the second item. The first candidate data may have the content “The entry fee for the swimming competition is KRW 30,000.” The second candidate data may have the content “The date of the swimming competition is June 17.” In this case, when determining the category of the first candidate data by the first item and the category of the second candidate data by the second item, the electronic device may select both the first candidate data and the second candidate data as the input data.

In an embodiment, when the content of the first candidate data and the content of the second candidate data are compatible with the query, the electronic device may determine that the category of the content of the first candidate data and the category of the content of the second candidate data are different. In this case, that the content of the first candidate data and the content of the second candidate data are compatible with the query may indicate that a portion of the content of the first candidate data corresponding to the query and a portion of the content of the second candidate data corresponding to the query do not contradict each other, even if they are all included.

For example, a query (e.g., “Create a Jeju field trip report”) may request the generation of a Jeju field trip report. In this example, the first candidate data may include an image of the sea in Jeju Island, and the second candidate data may include an image of Jeju International Airport. When generating the Jeju field trip report, the electronic device may determine that content of the first candidate data and content of the second candidate data are in different categories and select both the first candidate data and the second candidate data as the input data, based on the image of the sea in Jeju Island of the first candidate data and the image of Jeju International Airport of the second candidate data being compatible.

In an embodiment, the electronic device may generate a response by applying a generative model to the query and the input data including the first candidate data and the second candidate data. The electronic device may determine, of the response, a first partial response derived from the first candidate data and a second partial response derived from the second candidate data. The electronic device may display, in an area corresponding to the first partial response, a first visual representation indicating information regarding the first candidate data. The electronic device may display, in an area corresponding to the second partial response, a second visual representation indicating information regarding the second candidate data.

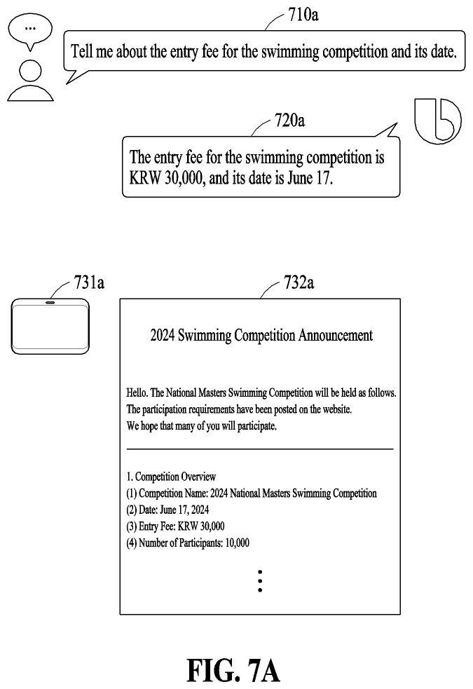

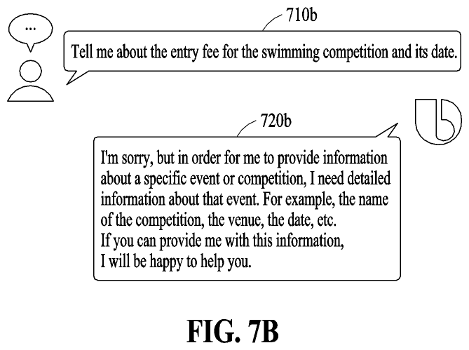

FIG. 7A is a diagram illustrating an example response to a query generated by an electronic device using specified source data, according to various embodiments. FIG. 7B is a diagram illustrating an example response to a query generated by an electronic device when no source data is specified, according to various embodiments.

An electronic device (e.g., the electronic device 101 of FIG. 1), according to an embodiment, may obtain a query (e.g., “Tell me about the entry fee for the swimming competition and its date”) (e.g., 710a and 710b).

Referring to FIG. 7A, in an embodiment, the electronic device may specify, as source data, at least a portion of internal data or external device data. The electronic device may determine, from the source data, a file of a 2024 swimming competition announcement having content of the 2024 swimming competition announcement as input data, and generate a response 720a (e.g., “The entry fee is KRW 30,000 and the date is June 17”) based on the input data. The electronic device may output the response 720a (e.g., play a sound corresponding to the response 720a or display a visual representation corresponding to the response 720a). The electronic device may display, in an area corresponding to the response 720a, a visual representation indicating information regarding the input data (e.g., the file of the 2024 swimming competition announcement). In FIG. 7A, the visual representation indicating the information regarding the input data may include, for example, a first visual representation 731a indicating an external device in which the input data is stored and a second visual representation 732a including at least a portion of the input data (e.g., a preview of the input data).

Referring to FIG. 7B, the electronic device may not specify internal data or external device data as source data (e.g., only search data may be specified as the source data) or may not specify any source data. The electronic device may determine that additional information (e.g., information to specify a swimming competition) is required to specify content (e.g., the entry fee for the swimming competition or the date of the swimming competition) in a query 710b. The electronic device may generate a response 720b that requests the additional information.

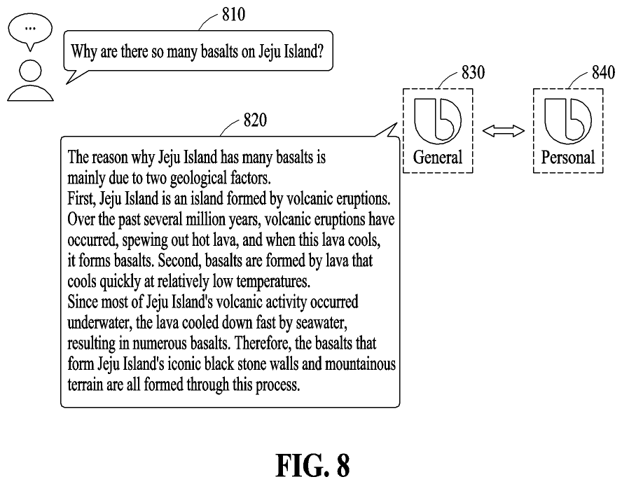

FIG. 8 is a diagram illustrating an example operation in which an electronic device displays a visual representation indicating information about a generative model used to generate a response, according to various embodiments.

An electronic device (e.g., the electronic device 101 of FIG. 1), according to an embodiment, may obtain a query 810 (e.g., “Why are there so many basalts on Jeju Island?”). The electronic device may, based on an analysis of the query 810 and/or a user input, specify search data as source data. Based on the query 810 being about public information (e.g., information that is not private) and/or the search data being specified as the source data, the electronic device may select, from between a first generative model processing private information and a second generative model processing public information, the second generative model. The electronic device may generate a response 820 using the second generative model. The electronic device may display a visual representation 830 (e.g., an icon) indicating the second generative model in an area corresponding to the response 820.

Although not explicitly shown in FIG. 8, in a case where the electronic device generates the response 820 using the first generative model, the electronic device may display a visual representation 840 indicating the first generative model in place of the visual representation 830 indicating the second generative model.

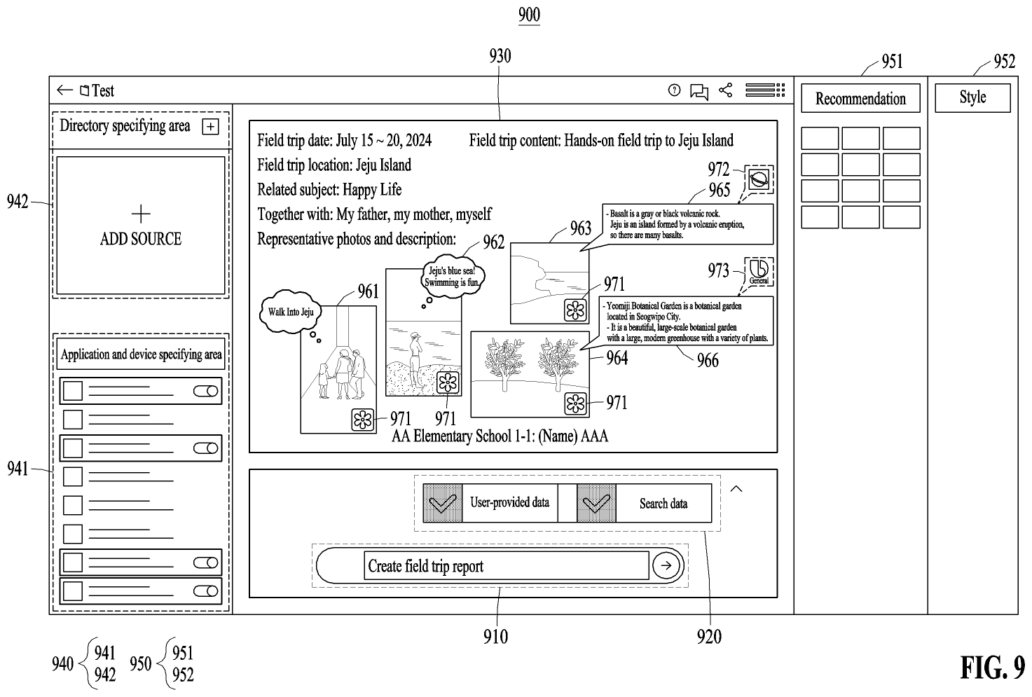

FIG. 9 is a diagram illustrating an example interface with which an electronic device obtains a query and outputs a response when user-provided data and search data are specified as source data, according to various embodiments.

An electronic device (e.g., the electronic device 101 of FIG. 1), according to an embodiment, may obtain a user input for obtaining a query and/or generating a response, and may provide an interface 900 (e.g., the interface 400 of FIG. 4) for outputting the generated response and/or information about the interface 900.

In an embodiment, the interface 900 may include a query input area 910, a source data specifying area 920, a response output area 930, a user-provided data specifying area 940, and/or a template providing area 950.

In an embodiment, the query input area 910 may include an area for receiving, from a user, a user input to generate a query.

In an embodiment, the source data specifying area 920 may include a button for specifying at least a portion of user-provided data (e.g., internal data or external device data) as source data and a button for specifying search data as the source data.

In an embodiment, the response output area 930 may include an area for outputting a response to the query. Examples of the response displayed via the response output area 930 are described in greater detail below.

In an embodiment, the user-provided data specifying area 940 may include a directory specifying area 942 and an application and device specifying area 941.

In an embodiment, the directory specifying area 942 may refer to an area for specifying the source data based on a directory (e.g., folder) and/or file. For example, in a case where a specific directory is added to the directory specifying area 942, the electronic device may specify data (e.g., file) stored in the specific directory as the source data. In a case where a specific file is added to the directory specifying area 942, the electronic device may specify the specific file as the source data.

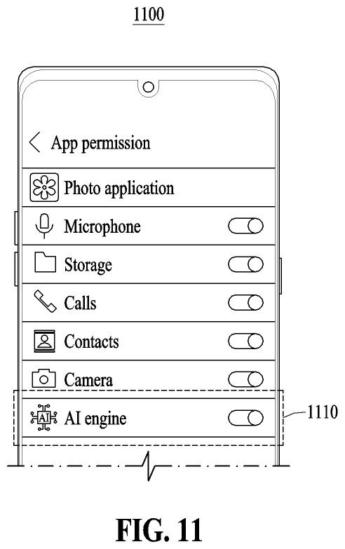

In an embodiment, the application and device specifying area 941 may refer to an area for specifying the source data based on an application or device (e.g., an external device). In the application and device specifying area 941, a list of application(s) and/or a list of device(s) may be displayed, and data related to a particular application and/or a particular device may be specified as the source data based on a user input to select the particular application and/or the particular device. For example, in the application and device specifying area 941, the electronic device may specify, as source data, data obtained or processed through a particular application from internal data, based on a user input to enable data of the application. For example, in the application and device specifying area 941, the electronic device may specify, as the source data, external device data corresponding to a particular device, based on a user input to enable data of the device. Conversely, the electronic device may exclude (e.g., remove), from the source data, data of a particular application and/or device based on a user input to disable the data of the application and/or device. The application and device specifying area 941 is described in greater detail below with reference to FIG. 11.

In an embodiment, the template providing area 950 may include a recommended template area 951 and a style area 952.

In an embodiment, the recommended template area 951 may refer to an area for providing recommended templates based on a query and/or source data among templates. In a case where a query requests an operation for generating a document, the electronic device may select one or more recommended templates from a plurality of candidate templates based on the query and/or source data. For example, the electronic device may display a list of the selected one or more recommended templates in the recommended template area 951.

In an embodiment, in a case where user-provided data is specified as the source data, the electronic device may select a recommended template independently of user information, or may select a recommended template with more consideration of the user information than in a case where the user-provided data is not specified as the source data. The user information may include information indicating the user's preference for a template (e.g., a candidate template). For example, the electronic device may select the recommended template by considering the user's preference when the user-provided data is specified as the source data, and may select the recommended template without considering the user's preference when the user-provided data is not specified as the source data.

In an embodiment, the style area 952 may refer to an area for providing a format of a response. The format of a response may include a format (e.g., font or size) of a text included in the response, an effect (e.g., filter) applied to an image included in the response, and the like.

In FIG. 9, the electronic device may specify, as the source data, at least a portion of the user-provided data and the search data based on the source data specifying area 920. Of the user-provided data, the electronic device may specify, as the source data, a directory and/or file added to the directory specifying area 942. The electronic device may specify, as the source data, data corresponding to an application and/or external device enabled via the application and device specifying area 941. The electronic device may then obtain a query (e.g., “Create a field trip report”) via the query input area 910. Based on the source data and the query, the electronic device may generate a response (e.g., a document including the field trip report) to the query.

Referring to FIG. 9, the response may be generated as a document including a plurality of images and a plurality of texts. For example, the response may include a first image 961, a second image 962, a third image 963, and a fourth image 964, and may include a first text 965 and a second text 966. Each of the images (e.g., the first image 961, the second image 962, the third image 963, or the fourth image 964) or each of the texts (e.g., the first text 965 or the second text 966) may be included in the response as a partial response.

For example, the electronic device may determine each of the first image 961, the second image 962, the third image 963, and the fourth image 964 as a partial response derived from input data obtained from a photo application. The electronic device may display a visual representation 971 indicating the photo application in an area corresponding to each of the first image 961, the second image 962, the third image 963, and the fourth image 964.

For example, the electronic device may determine the first text 965 as a partial response derived from search data. The electronic device may display a visual representation 972 indicating the search data and/or a web page corresponding to the search data, in an area corresponding to the first text 965.

For example, the electronic device may determine the second text 966 as a partial response generated by a generative model (e.g., a partial response derived from data learned by the generative model and a partial response that is not derived from the input data). The electronic device may display a visual representation 973 indicating what is generated by the generative model, in an area corresponding to the second text 966.

Although not explicitly shown in FIG. 9, the electronic device may generate a plurality of versions of responses to a query (e.g., “Create a field trip report”). For example, the electronic device may generate a first version of a first response and a second version of a second response. The first version, also referred to as a private version, may indicate that a higher percentage of user-provided data is used in the first response than in the second response. The second version, also referred to as a public version, may indicate that a lower percentage of user-provided data is used in the second response than in the first response.

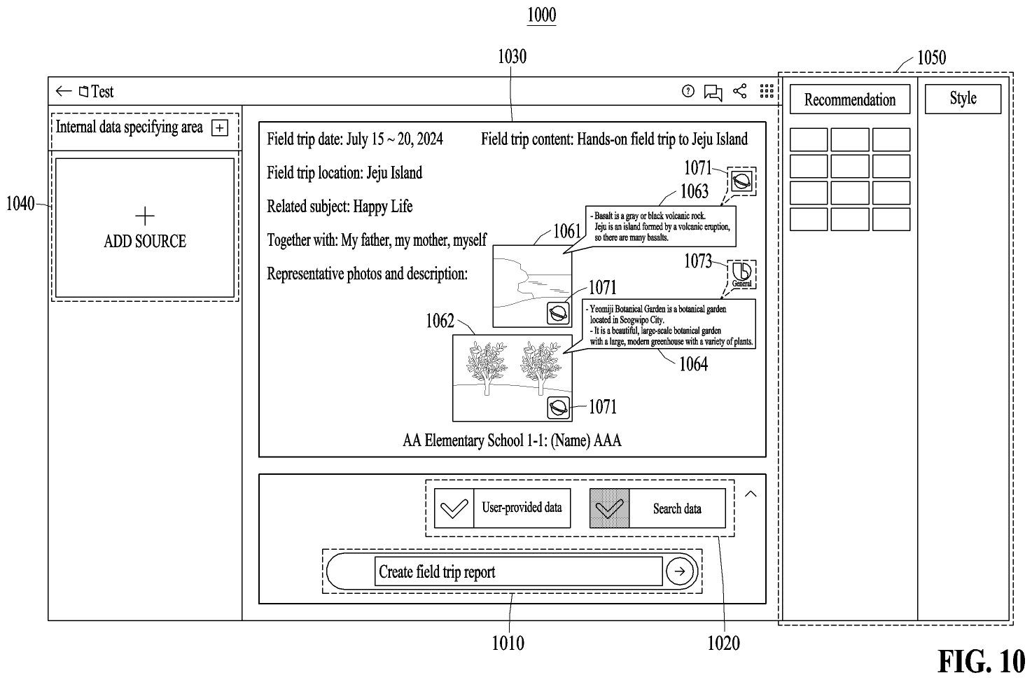

FIG. 10 is a diagram illustrating an example interface with which an electronic device obtains a query and outputs a response when user-provided data is not specified as source data but search data is specified as the source data, according to various embodiments.

An electronic device (e.g., the electronic device 101 of FIG. 1), according to an embodiment, may provide an interface 1000 (e.g., the interface 400 of FIG. 4 or the interface 900 of FIG. 9) for obtaining a user input for obtaining a query and/or generating a response and for outputting the generated response, and/or information about the interface 1000.

In an embodiment, the interface 1000 may include a query input area 1010, a source data specifying area 1020, a response output area 1030, an internal data specifying area 1040, and a template providing area 1050. Each of the areas may be the same or similar to those described with reference to FIGS. 4 and/or 9.

In FIG. 10, the electronic device may specify search data as source data, rather than specifying user-provided data as the source data, based on the source data specifying area 1020. The electronic device may then obtain a query (e.g., “Create a field trip report”) via the query input area 1010. Based on the source data and the query, the electronic device may generate a response (e.g., a document including the field trip report) to the query.

Referring to FIG. 10, the response may be generated as a document including a plurality of images and a plurality of texts. For example, the response may include a first image 1061, a second image 1062, a first text 1063, and a second text 1064. Each of the images (e.g., the first image 1061 or the second image 1062) or each of the texts (e.g., the first text 1063 or the second text 1064) may be included in the response as a partial response.

For example, the electronic device may determine each of the first image 1061 and the second image 1062 as a partial response derived from the search data. The electronic device may display a visual representation 1071 indicating the search data and/or web page, in an area corresponding to each of the first image 1061 and the second image 1062.

For example, the electronic device may determine the first text 1063 as a partial response derived from the search data. The electronic device may display the visual representation 1071 indicating the search data and/or web page, in an area corresponding to the first text 1063.

For example, the electronic device may determine the second text 1064 as a partial response generated by a generative model (e.g., a partial response derived from data learned by the generative model or a partial response not derived from input data). The electronic device may display a visual representation 1073 indicating what is generated by the generative model, in an area corresponding to the second text 1064.

FIG. 11 is a diagram illustrating an example screen for specifying data related to a particular application as source data, according to various embodiments.

An electronic device (e.g., the electronic device 101 of FIG. 1), according to an embodiment, may obtain a user input for setting whether data related to a particular application is to be used as source data, on a screen 1100 for setting permissions for each application. The data related to the application may include data obtained or processed through the application.

Referring to FIG. 11, the electronic device may display the screen 1100 for setting permissions for a particular application (e.g., a photo application). For example, the screen 1100 may include an area 1110 for setting permissions to use data related to the application as input data and/or source data for a generative model.

In an embodiment, in the area 1110, the electronic device may specify, as the source data, data related to a particular application when internal data (or user-provided data) is specified as the source data, based on a user input to set the data related to the application to be available as the input data and/or source data of the generative model. Alternatively, the electronic device may exclude, from the source data, the data related to the application, even if the internal data (or user-provided data) is specified as the source data, based on a user input to set the data related to the application to be unavailable as the input data and/or source data of the generative model.

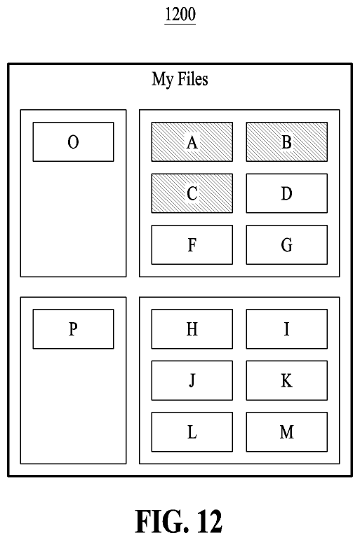

FIG. 12 is a diagram illustrating an example screen where an electronic device specifies source data based on a directory, according to various embodiments.

An electronic device (e.g., the electronic device 101 of FIG. 1), according to an embodiment, may obtain a user input to set whether to use a particular directory and/or a particular file as source data.

For example, in an application and device specifying area (e.g., the application and device specifying area 941 of FIG. 9) of an interface, the electronic device may display a screen 1200 for selecting at least a portion of internal data of the electronic device based on a directory and/or file, in response to a user input for selecting a file application.

Referring to FIG. 12, the screen 1200 may include a list of at least some directories of the internal data of the electronic device. For example, the screen 1200 may include a plurality of buttons respectively corresponding to a plurality of directories. In response to a user input for selecting a button corresponding to a particular directory (e.g., Directory A), the electronic device may specify, as the source data, data stored in that directory. FIG. 12 shows an example case where some directories (e.g., directory A, directory B, and directory C) are specified as the source data, and the remaining directories (e.g., directory D, directory F, directory G, directory H, directory I, directory J, directory K, directory L, directory M, directory O, or directory P) are not specified as the source data.

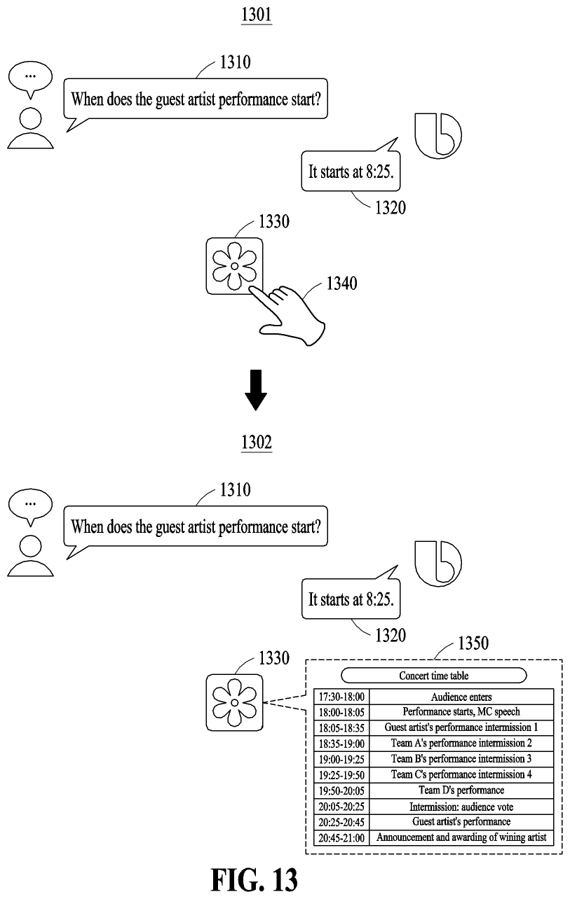

FIG. 13 is a diagram illustrating example screens where an electronic device includes a response, according to various embodiments.

An electronic device (e.g., the electronic device 101 of FIG. 1), according to an embodiment, may display a response 1320 (e.g., “It starts at 8:25”) generated based on a query 1310 (e.g., “When does the guest artist performance start?”).

On screen 1301, the electronic device may display, in an area corresponding to the generated response 1320, a visual representation 1330 indicating information (e.g., a photo application) regarding input data from which the response 1320 is derived.

On screen 1302, the electronic device may display at least a portion 1350 of the input data, based on obtaining a user input 1340 to the displayed visual representation 1330. Referring to FIG. 13, the electronic device may display a preview including the portion 1350 of the input data in an area corresponding to the response 1320.

However, without limitation, the electronic device may output (e.g., display) the input data by executing an application (e.g., the photo application) that provides the input data in response to the user input 1340.

In an embodiment, by providing at least a portion of the input data via the user input 1340 to the visual representation 1330, the electronic device may facilitate verification of the response 1320 or partial response 1320 based on the input data for the user.

Although not explicitly shown in FIG. 13, the electronic device may display one of the screen 1301 and the screen 1302 based on information about a display of the electronic device. The information about the display may include, for example, a resolution of the display, a size of the display, or a resolution and/or size of a window allocated to display an interface (or the response 1320).

For example, in a case where the electronic device is a smartphone having a display (e.g., a small display) with a resolution below a threshold resolution, the electronic device may display the screen 1301 for displaying the response 1320. On the screen 1301, the visual representation 1330 may be displayed as a visual representation indicating information regarding the input data. In a case where the electronic device is a laptop having a display (e.g., a large display) with a resolution above the threshold resolution, the electronic device may display the screen 1302 for displaying the response 1320. On the screen 1302, the visual representation 1330 and the at least a portion 1350 of the input data may be displayed, as a visual representation indicating the information regarding the input data.

FIG. 14 is a diagram illustrating an example configuration for performing operations of an electronic device, according to various embodiments.

An electronic device (e.g., the electronic device 101 of FIG. 1), according to an embodiment, may include a query analysis module 1410, an input data selection module 1420 (e.g., the input data selection module 530 of FIG. 5 or the input data selection module 630 of FIG. 6), a generative model interface module 1430, a response generation module 1440, and an input data-partial response correspondence module 1450. Each of these modules may include various circuitry (e.g., processing circuitry) and/or executable program instructions.

In an embodiment, the query analysis module 1410 may obtain a query 1401 and/or analyze the obtained query 1401. As described above, a result of analyzing the obtained query 1401 may be used to specify source data, extract candidate data, select input data, and/or select a generative model.

In an embodiment, the input data selection module 1420 may obtain the result of analyzing the query 1401 from the query analysis module 1410 and select input data from specified source data and/or an extracted plurality of pieces of candidate data. For example, the source data may be specified as at least a portion of internal data 1421, at least a portion of external device data 1422, and/or search data 1423. The input data selection module 1420 may transmit the selected input data to the generative model interface module 1430.

In an embodiment, the generative model interface module 1430 may receive the query 1401 and/or the result of analyzing the query 1401 from the query analysis module 1410. The generative model interface module 1430 may obtain the input data from the input data selection module 1420. For example, the generative model interface module 1430 may select a generative model from a plurality of candidate generative models and/or obtain information about the selected generative model. The generative model interface module 1430 may transmit the query 1401, the input data, and/or the information about the generative model to the response generation module 1440.

In an embodiment, the response generation module 1440 may generate a response 1441 by applying the query 1401 and the input data to the generative model based on the information received from the generative model interface module 1430. The response generation module 1440 may transfer the generated response 1441 to the input data-partial response correspondence module 1450.

In an embodiment, the input data-partial response correspondence module 1450 may receive the input data from the response generation module 1440 and/or the input data selection module 1420. The input data-partial response correspondence module 1450 may receive the response 1441 from the response generation module 1440. The input data-partial response correspondence module 1450 may determine a corresponding relationship 1451 between the input data (or a plurality of pieces of partial input data) and a plurality of partial responses. As described above with reference to FIGS. 2 through 13, a visual representation indicating information regarding the input data may be displayed around an area where a partial response corresponding to the input data (e.g., a partial response derived from the input data) is displayed.

According to an example embodiment, an electronic device may include: a display; at least one processor, comprising processing circuitry; and a memory configured to store instructions, wherein at least one processor, individually and/or collectively, is configured to execute the instructions and to cause the electronic device to: based on obtaining a query for source data, extract a plurality of pieces of candidate data related to the query from the source data; select, from the extracted plurality of pieces of candidate data, input data based on contents of the plurality of pieces of candidate data; generate a response to the query by applying the query and the selected input data to a generative model; determine a partial response of the response derived from the selected input data; and display, via the display, a visual representation indicating information regarding the selected input data, in an area corresponding to the determined partial response.

The visual representation may indicate at least one of an application used to obtain or process the input data, a directory in which the input data is stored, an access path for accessing a page including the input data, or an external device sharing the input data with the electronic device.

At least one processor, individually and/or collectively, may be configured to cause the electronic device to: based on content of first candidate data and content of second candidate data being the same, select one of the first candidate data and the second candidate data as the input data; and display a visual representation indicating information regarding the first candidate data and a visual representation indicating information regarding the second candidate data, in the area corresponding to the partial response.

At least one processor, individually and/or collectively, may be configured to cause the electronic device to: based on the content of the first candidate data and the content of the second candidate data being different, select, from between the first candidate data and the second candidate data, one candidate data more recently obtained or processed than the other as the input data.

At least one processor, individually and/or collectively,, may be configured to cause the electronic device to: based on the content of the first candidate data and the content of the second candidate data being in different categories, select the first candidate data and the second candidate data as the input data; determine, of the response, a first partial response derived from the first candidate data and a second partial response derived from the second candidate data; and display a first visual representation indicating information regarding the first candidate data in an area corresponding to the first partial response and a second visual representation indicating information regarding the second candidate data in an area corresponding to the second partial response.

At least one processor, individually and/or collectively,, may be configured to cause the electronic device to: based on obtaining an input to the displayed visual representation, display at least a portion of the input data.

At least one processor, individually and/or collectively, may be configured to cause the electronic device to: determine a similarity level between a plurality of candidate partial responses included in the response and the input data; and based on the similarity level between each candidate partial response and the input data, determine at least one candidate response as the partial response derived from the input data.

At least one processor, individually and/or collectively, may be configured to cause the electronic device to: based on the input, determine the source data to be at least one of: at least a portion of internal data stored in the memory, at least a portion of external device data stored in another electronic device connected to the electronic device, or search data obtainable via a search server.

At least one processor, individually and/or collectively, may be configured to cause the electronic device to: based on the query being a query about private information of a user, determine the source data to be the internal data stored in the memory of the electronic device.

At least one processor, individually and/or collectively, may be configured to cause the electronic device to: obtain summary data of the internal data stored in the memory; based on obtaining the query, determine whether the query is answerable with the internal data using the summary data and the query (; based on the query being answerable with the internal data, specify the source data including the internal data; and based on the query not being answerable with the internal data, specify the source data including at least one of the external device data or the search data.

According to an example embodiment, a method performed by an electronic device may include: extracting, based on obtaining a query for source data, a plurality of pieces of candidate data related to the query from the source data; selecting, from the extracted plurality of pieces of candidate data, input data based on contents of the plurality of pieces of candidate data; generating a response to the query by applying the query and the selected input data to a generative model; determining a partial response of the response derived from the selected input data; and displaying, via a display, a visual representation indicating information regarding the selected input data, in an area corresponding to the determined partial response.

The displayed visual representation may indicate at least one of an application used to obtain or process the input data, a directory in which the input data is stored, an access path for accessing a page including the input data, or an external device sharing the input data with the electronic device.

The selecting the input data may include: based on content of first candidate data and content of second candidate data being the same, selecting one of the first candidate data and the second candidate data as the input data. The displaying the visual representation may include: displaying, in the area corresponding to the partial response, a visual representation indicating information regarding the first candidate data and a visual representation indicating information regarding the second candidate data.

The selecting the input data may include: based on the content of the first candidate data and the content of the second candidate data being different, selecting, from between the first candidate data and the second candidate data, one that is more recently obtained or processed than the other as the input data.

The selecting the input data may include: based on the content of the first candidate data and the content of the second candidate data being in different categories, selecting the first candidate data and the second candidate data as the input data. The determining the partial response may include: determining a first partial response derived from the first candidate data and a second partial response derived from the second candidate data. The displaying the visual representation may include: displaying a first visual representation indicating information regarding the first candidate data in an area corresponding to the first partial response and a second visual representation indicating information regarding the second candidate data in an area corresponding to the second partial response.

The method may further include: based on obtaining an input to the displayed visual representation, displaying at least a portion of the input data.

The determining the partial response may include: determining a similarity level between a plurality of candidate partial responses included in the response and the input data; and based on the similarity level between each candidate partial response and the input data, determining at least one candidate response as the partial response derived from the input data.

The method may further include: based on the input, determining the source data to be at least one of: at least a portion of internal data stored in a memory of the electronic device, at least a portion of external device data stored in another electronic device connected to the electronic device, or search data obtainable via a search server.

The method may further include: based on the query being a query about private information of a user, determining the source data to be the internal data stored in the memory of the electronic device.

According to various embodiments of the present disclosure, an electronic device may be a device of various types. The electronic device may include, as non-limiting examples, a portable communication device (e.g., a smartphone, etc.), a computing device, a portable multimedia device, a portable medical device, a camera, a wearable device, consumer electronics, or the like. However, the electronic device is not limited to the foregoing examples.

It is to be understood that various embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things unless the relevant context clearly indicates otherwise. As used herein, “A or B,” “at least one of A and B,” “at least one of A or B,” “A, B, or C,” “at least one of A, B, and C,” and “at least one of A, B, or C,” each of which may include any one of the items listed together in the corresponding one of the phrases, or all possible combinations thereof. Terms such as “first” and “second,” or “initial” or “subsequent” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), the element may be coupled with the other element directly (e.g., by wire), wirelessly, or via a third element.

As used in connection with certain embodiments of the disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in the form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to various embodiments of the present disclosure, a method described herein may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The various embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct and/or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computing systems so that the software is stored and executed in a distributed fashion. The software and data may be stored by one or more non-transitory computer-readable recording mediums.

The methods according to the various example embodiments described above may be recorded in non-transitory computer-readable media including program instructions to implement various operations of the above-described examples. The media may also include, alone or in combination with the program instructions, data files, data structures, and the like. The program instructions recorded in the media may be specially designed and constructed for the purposes of examples, or they may be of the kind well-known and available to a person of ordinary skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, RAM, flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the various example embodiments described above, or vice versa.

While the disclosure has been illustrated and described with reference to various example embodiments, it will be understood that the various embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a display;
at least one processor, comprising processing circuitry; and
a memory configured to store instructions, wherein at least one processor, individually and/or collectively, is configured to execute the instructions and to cause the electronic device to:
based on obtaining a query for source data, extract a plurality of pieces of candidate data related to the query from the source data;
select, from the extracted plurality of pieces of candidate data, input data based on contents of the plurality of pieces of candidate data;
generate a response to the query by applying the query and the selected input data to a generative model;
determine a partial response of the response derived from the selected input data; and
display, via the display, a visual representation indicating information regarding the selected input data, in an area corresponding to the determined partial response.

2. The electronic device of claim 1, wherein the visual representation indicates at least one of an application used to obtain or process the input data, a directory in which the input data is stored, an access path for accessing a page including the input data, or an external device sharing the input data with the electronic device.

3. The electronic device of claim 1, wherein at least one processor, individually and/or collectively, is configured to cause the electronic device to:
based on content of first candidate data and content of second candidate data being the same, select one of the first candidate data and the second candidate data as the input data; and
display a visual representation indicating information regarding the first candidate data and a visual representation indicating information regarding the second candidate data, in the area corresponding to the partial response.

4. The electronic device of claim 1, wherein at least one processor, individually and/or collectively, is configured to cause the electronic device to:
based on the content of the first candidate data and the content of the second candidate data being different, select, from between the first candidate data and the second candidate data, candidate data more recently obtained or processed than the other as the input data.

5. The electronic device of claim 1, wherein at least one processor, individually and/or collectively, is configured to cause the electronic device to:
based on the content of the first candidate data and the content of the second candidate data being in different categories, select the first candidate data and the second candidate data as the input data;
determine, of the response, a first partial response derived from the first candidate data and a second partial response derived from the second candidate data; and
display a first visual representation indicating information regarding the first candidate data in an area corresponding to the first partial response and a second visual representation indicating information regarding the second candidate data in an area corresponding to the second partial response.

6. The electronic device of claim 1, wherein at least one processor, individually and/or collectively, is configured to cause the electronic device to:
based on obtaining an input to the displayed visual representation, display at least a portion of the input data.

7. The electronic device of claim 1, wherein at least one processor, individually and/or collectively,, is configured to cause the electronic device to:
determine a similarity level between a plurality of candidate partial responses included in the response and the input data; and
based on the similarity level between each candidate partial response and the input data, determine at least one candidate response as the partial response derived from the input data.

8. The electronic device of claim 6, wherein at least one processor, individually and/or collectively, is configured to cause the electronic device to:
based on the input, determine the source data to be at least one of: at least a portion of internal data stored in the memory, at least a portion of external device data stored in another electronic device connected to the electronic device, or search data obtainable via a search server.

9. The electronic device of claim 1, wherein at least one processor, individually and/or collectively, is configured to cause the electronic device to:
based on the query being a query about private information of a user, determine the source data to be the internal data stored in the memory of the electronic device.

10. The electronic device of claim 1, wherein at least one processor, individually and/or collectively, is configured to cause the electronic device to:
obtain summary data of the internal data stored in the memory;
based on obtaining the query, determine whether the query is answerable with the internal data using the summary data and the query;
based on the query being answerable with the internal data, specify the source data including the internal data; and
based on the query not being answerable with the internal data, specify the source data including at least one of the external device data or the search data.

11. A method performed by an electronic device, comprising:
extracting, based on obtaining a query for source data, a plurality of pieces of candidate data related to the query from the source data;
selecting, from the extracted plurality of pieces of candidate data, input data based on contents of the plurality of pieces of candidate data;
generating a response to the query by applying the query and the selected input data to a generative model;
determining a partial response of the response derived from the selected input data; and
displaying, via a display, a visual representation indicating information regarding the selected input data, in an area corresponding to the determined partial response.

12. The method of claim 11, wherein the displayed visual representation indicates at least one of an application used to obtain or process the input data, a directory in which the input data is stored, an access path for accessing a page including the input data, or an external device sharing the input data with the electronic device.

13. The method of claim 11, wherein the selecting the input data comprises:
based on content of first candidate data and content of second candidate data being the same, selecting one of the first candidate data and the second candidate data as the input data, and
the displaying the visual representation comprises:
displaying, in the area corresponding to the partial response, a visual representation indicating information regarding the first candidate data and a visual representation indicating information regarding the second candidate data.

14. The method of claim 11, wherein the selecting the input data comprises:
based on the content of the first candidate data and the content of the second candidate data being different, selecting, from between the first candidate data and the second candidate data, one that is more recently obtained or processed than the other as the input data.

15. The method of claim 11, wherein the selecting the input data comprises:
based on the content of the first candidate data and the content of the second candidate data being in different categories, selecting the first candidate data and the second candidate data as the input data,
the determining the partial response comprises:
determining a first partial response derived from the first candidate data and a second partial response derived from the second candidate data, and
the displaying the visual representation comprises:
displaying a first visual representation indicating information regarding the first candidate data in an area corresponding to the first partial response and a second visual representation indicating information regarding the second candidate data in an area corresponding to the second partial response.

16. The method of claim 11, further comprising:
based on obtaining an input to the displayed visual representation, displaying at least a portion of the input data.

17. The method of claim 11, wherein the determining the partial response comprises:
determining a similarity level between a plurality of candidate partial responses included in the response and the input data; and
based on the similarity level between each candidate partial response and the input data, determining at least one candidate response as the partial response derived from the input data.

18. The method of claim 16, further comprising:
based on the input, determining the source data to be at least one of: at least a portion of internal data stored in a memory of the electronic device, at least a portion of external device data stored in another electronic device connected to the electronic device, or search data obtainable via a search server.

19. The method of claim 11, further comprising:
based on the query being a query about private information of a user, determining the source data to be the internal data stored in the memory of the electronic device.

20. A non-transitory computer-readable storage medium storing one or more computer programs comprising instructions, which when executed by at least one processor, comprising processing circuitry of an electronic device, individually and/or collective, cause the electronic device to perform the method of claim 11.
